(19) United States
(12) Patent Application Publication
(10) Pub. No.: US 2009/0050097 A1
(43) Pub. Date: Feb. 26, 2009

(54) FLAP ARRANGEMENT FOR A FRESH GAS ARRANGEMENT

(76) Inventor: Bernd Albiez, Rickenbach (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/993,409

(22) PCT Filed: Jun. 16, 2006
(86) PCT No.: PCT/DE06/01027

§ 371 Date: Aug. 5, 2008

(30) Foreign Application Priority Data
Jun. 22, 2005 (DE) 10 2005 029 193.7

(51) Int. Cl. F02B 27/02

(52) U.S. Cl. 123/184.56; 123/184.54

(57) ABSTRACT

The invention relates to an arrangement (4) of a flap (5) in a channel (2) of a fresh gas arrangement (1) in order to supply an internal combustion engine, in particular, a motor vehicle, with fresh gas. Said arrangement comprises an actuating device (7) which is used to pivot the flap (5) about a pivotable axis (6), The actuation device (7) comprises an actuator (8) which engages with the flap such that it can be pivoted in a manner which is eccentric in relation to the pivotable axis (6) during the actuation thereof, in order to reduce the load of the actuation device (7).

The present invention relates to an arrangement of the valve in a channel of a fresh gas system for supplying fresh gas to an internal combustion engine, in particular in a motor vehicle. The invention also relates to a fresh gas system equipped with such a valve arrangement.

An internal combustion engine has a fresh gas system comprising multiple channels for supplying fresh gas to the individual cylinders of the engine. So-called tumble valves may be arranged in these channels, which are also known as “intake pipes.” With the help of tumble valves, a charge flow can be generated for the respective cylinder as needed, said flow rotating parallel to the piston-bolt axis and perpendicular to the vertical axis of the cylinder, and thereby implementing a shifting charge operation In this way, the turbulent kinetic energy in the cylinder can be increased, which makes it possible to increase the quantity of exhaust gas recycled. Greater recycling rates lead to dethrottling of the internal combustion engine, which lowers its fuel consumption, and leads to a reduction in the combustion chamber temperature, which reduces NO₂ production in the combustion process. Tumble valves are used primarily in gasoline engines.

So-called swirl valves may also be used in the channels or intake pipes. With the help of swirl valves, it is possible to generate a charge flow rotating about the vertical axis of the cylinder. With the help swirl valves, a channel of a pair of channels allocated to a cylinder can be closed to varying extents to thereby increase the turbulent kinetic energy in the combustion chamber. In this way the internal combustion engine can be adapted relatively accurately to different operating states. In addition to the advantages mentioned above which derive in combination with a tumble valve, particulate emissions can be reduced and the particle size decreased when using swirl valves, especially with diesel engines.

It is fundamentally possible to arrange such a valve in a rotationally fixed manner on a drive shaft. By rotating the drive shaft, the desired swivel adjustment of the valve can be implemented, with the drive shaft necessarily running coaxially with the swivel axis of the valve. Depending on the operating state of the internal combustion engine and depending on the valve setting, relatively high flow forces can act on the valve and must be absorbed by the drive shaft. In this way an operating device for swivel adjustment of the valve is exposed to relatively great loads and stresses. This may have negative effects on the lifetime of the actuating device. Likewise, the flow forces acting on the valves can trigger relative movements of the valves which may be associated with an unwanted noise production.

The present invention relates to the problem of providing an improved embodiment for a valve arrangement of the type defined in the preamble and/or a fresh gas system equipped with such a valve such that this embodiment is characterized in particular by reduced stress on the respective actuating device.

This problem is solved according to this invention by the features of the independent claims. Advantageous embodiments are the subject matter of the dependent claims.

The present invention is based on the general idea of driving the respective valve with the help of a separate actuator for pivoting, in which case the respective actuator acts eccentrically on the valve with respect to the pivot axis of the valve. Due to the eccentric introduction of force into the valve, advantageous lever forces can be achieved so that on the one hand only relatively low adjusting forces are required for adjusting the valve while on the other hand the flow forces acting on the valve are transmitted in a reduced form according to the lever action when they are transferred to the actuator and thus to the actuating device. The loads acting on the actuating device are therefore reduced, so that the latter device has a longer lifetime while retaining the same stability or it may be designed with a reduced stability while maintaining the same lifetime and therefore may be manufactured less expensively.

The actuating device may preferably be designed so that when the actuator is actuated, it rotates about an axis of rotation running parallel with and eccentric to the pivot axis. Then the actuator is connected to a drive shaft in a rotationally fixed manner, the drive shaft running parallel and eccentric to the pivot axis and extending coaxially with the axis of rotation in particular. In this way it is possible in particular to arrange an actuating drive for driving the drive shaft outside of the channel, In particular, this also makes it possible to provide a common actuating drive for multiple actuators, expediently driving the actuators in synchronization via a common drive shaft.

The valve may be mounted in pivot bearings, e.g., by means of bearing journals extending coaxially with the pivot axis. Likewise the valve may be arranged on a bearing shaft extending coaxially with the pivot axis. In particular, several valves of neighboring valve arrangements may be arranged simultaneously on such a bearing shaft. This common bearing shaft and the joint drive shaft which is expediently provided then extend in parallel and eccentrically, i.e., at a distance from one another, to implement the aforementioned advantageous lever ratios.

Additional important features and advantages of the invention are derived from the subclaims, the drawings and the respective description of the figures on the basis of the drawings.

It is self-evident that the features mentioned above and those yet to be explained below may be used not only in the particular combination given but also in other combinations or alone without going beyond the scope of the present invention.

Preferred exemplary embodiments of the invention are depicted in the drawings and explained in greater detail in the following description, where the same reference numerals refer to the same or similar or functionally same components.

They each show, in schematic diagrams,

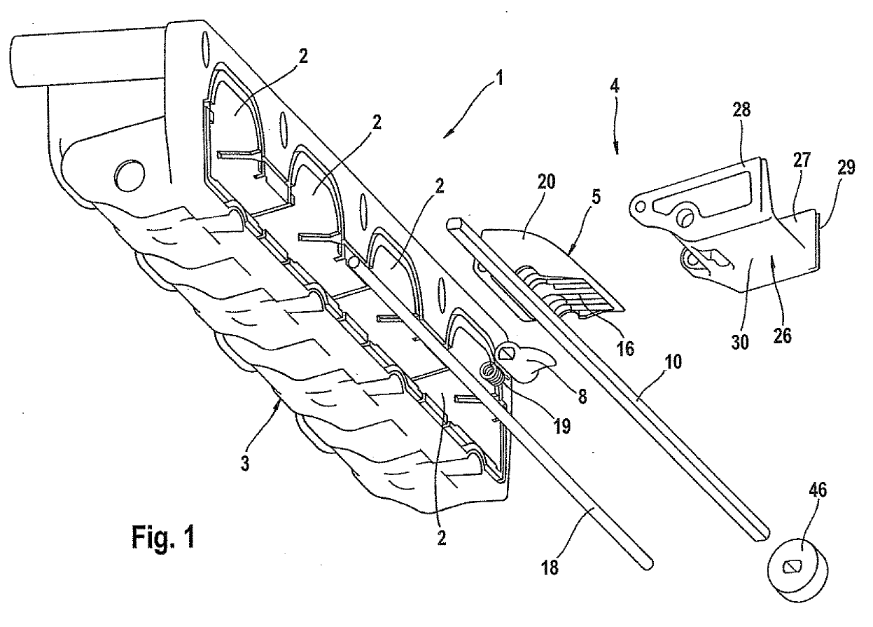

FIG. 1 a greatly simplified perspective exploded diagram of a fresh gas system in a first embodiment,

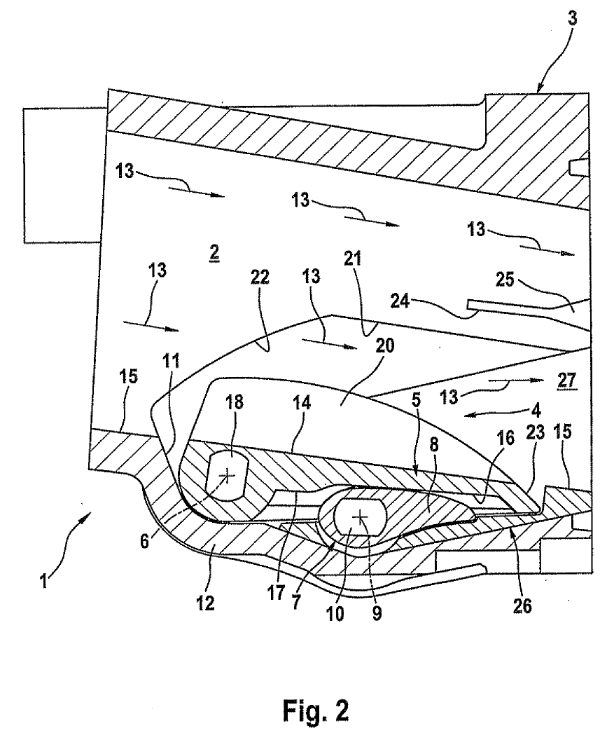

FIG. 2 a longitudinal section through a valve arrangement of the fresh gas system from FIG. 1,

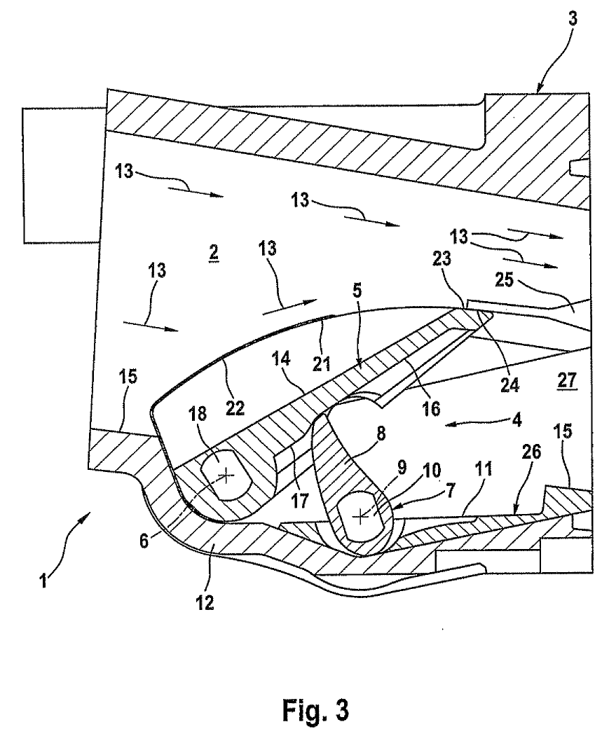

FIG. 3 a view like that in FIG. 2 but with a different valve setting,

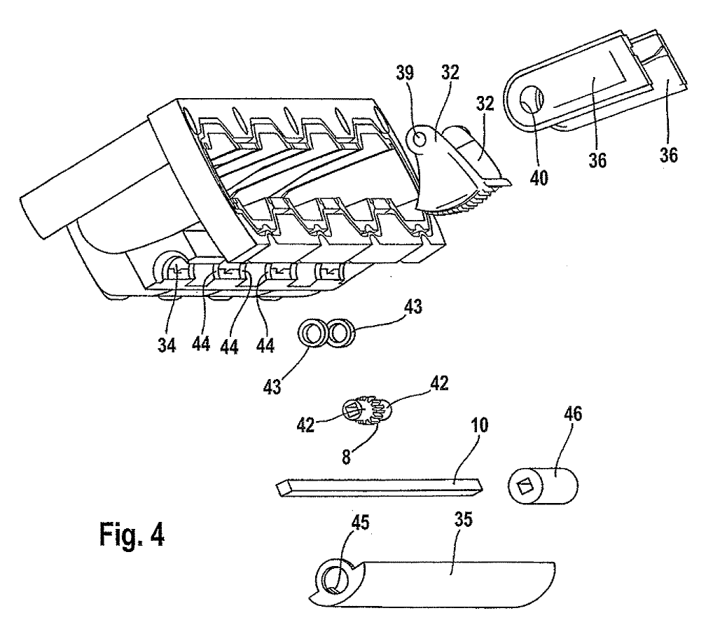

FIG. 4 a view like that in FIG. 1 but with a second embodiment,

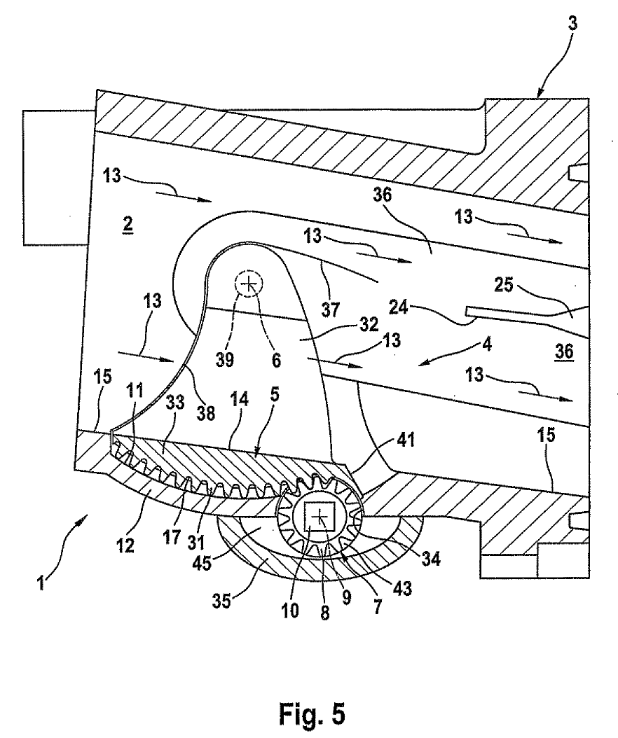

FIG. 5 a longitudinal section through a valve arrangement of the fresh gas system from FIG. 4,

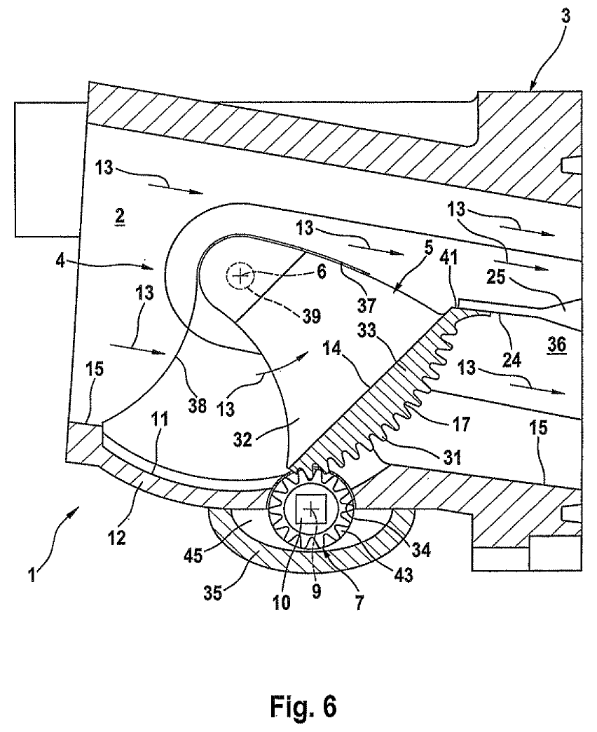

FIG. 6 a view like that in FIG. 5, but with a different valve setting.

According to FIGS. 1 and 4, an inventive fresh gas system 1 comprises multiple channels 2 which are combined here in a channel block 3. The fresh gas system 1 serves to supply fresh gas to an internal combustion engine (not shown here), preferably in a motor vehicle. The individual channels 2 serve to supply the fresh gas to a cylinder of the internal combustion engine. The channel block 3 is provided for mounting on an engine block Of the internal combustion engine, for example.

At least one of the channels 2 is equipped with an inventive valve arrangement 4 which is explained in greater detail with reference to FIGS. 2 and 3 as well as 5 and 6. Preferably several channels 2, usually all of them are equipped with such a valve arrangement 4. Only one such valve arrangement 4 is shown as an example in FIG. 1 and/or FIG. 4, with individual components of the valve arrangement 4 being adapted for use in the fresh gas system 1 equipped with multiple valve arrangements, which is also explained in greater detail below with reference to FIGS. 1 and 4.

According to FIGS. 2 and 3 as well as 5 and 6, the respective valve arrangement 4 comprises a valve S which is arranged in the channel 2 and is pivotable about a pivot axis 6 between a starting position shown in FIGS. 2 and 5 and an end position shown in FIGS. 3 and 6. In order to be able to actuate the valve 5 for pivoting about its pivot axis 6, an actuating device 7 is provided, having an actuator 8. This actuator 8 cooperates with the valve 5 for the pivot adjustment of the latter. To do so, the actuator 8 acts on the valve 5 eccentrically with respect to the pivot axis 6. In other words the transfer of force between the actuator 8 and the valve 5 is accomplished at a location at a distance from the pivot axis 6, resulting in the actuating forces prevailing on the actuator 8.

In the embodiments shown here, the actuator 8 is mounted so it is rotationally adjustable about an axis 9 of rotation. The actuator 8 rotates about this axis of rotation 9 in pivot actuation of the valve S. This axis of rotation 9 extends parallel to the pivot axis 6 but is also eccentric with respect to the pivot axis 6, i.e., is arranged at a distance from it. A drive shaft 10 to which the actuator 8 is attached in a rotationally fixed manner is preferably also provided. This drive shaft 10 extends here coaxially with the axis of rotation 9 and thus runs in parallel with and eccentrically to the pivot axis 6. The rotationally fixed coupling between the actuator 8 and the drive shaft 10 is accomplished here by a form-fitting connection.

In addition, a trough 11 may be provided for accommodating the valve 5 in the starting position. This trough 11 is designed in a channel wall 12 which borders the channel 2. The valve 5 is arranged so it is countersunk in this trough 11 in the starting position. A front side 14 of the valve 5 is exposed to the channel 2, i.e., to the fresh gas flow 13 (indicated here by arrows), which develops during operation of the internal combustion engine, and is arranged in a manner such that it is integrated into the contour in an inside contour 15 of the channel wall 12 which is exposed to the fresh gas flow 13. The actuator 8 is expediently also arranged in this trough 11 and is thus countersunk in the channel wall 12. Therefore, the axis of rotation 9 and the drive shaft 10 are arranged so they are countersunk in the channel wall 12.

The valve 5, which is countersunk in the trough 11, is more or less outside of the fresh gas flow 13 and has essentially no interfering influence on the flow.

According to FIGS. 2 and 3, with the valve arrangement 4 that is installed in the fresh gas system 1 illustrated in FIG. 1, the actuator 8 is designed as a cam, also labeled with numeral 8 below. The cam $ is attached to the drive shaft 10 in a rotationally fixed manner and cooperates with a cam slider 16 which is designed on the valve 5. This cam slider 16 is expediently designed on a back side 17 of the valve 5 which faces away from the fresh gas flow 13. The cam 8 is oriented in the starting position according to FIG. 2 in such a way that it protrudes away from the axis of rotation 9 on the side facing away from the pivot axis 6. In this way and in particular due to a special contour on the cam 8 and/or on the cam slider 16, this yields the resulting kinematics for actuation of the valve 5 representing an optimized compromise between the lowest possible adjusting forces on the one hand and the fastest possible adjustability on the other hand. At the same time, such kinematics allow an especially advantageous adaptation to the flow forces acting on the valve 5, the farther the valve 5 is pivoted out of its starting position.

In the embodiment shown here the valve 5 is mounted on a bearing shaft 18. The bearing shaft 18 extends coaxially to the pivot axis 6. In the exemplary embodiment shown here the valve 5 is arranged on the bearing shaft 18 in a rotationally fixed manner, which is achieved by a corresponding form-fitting coupling, for example. Accordingly in this embodiment the bearing shaft is mounted to rotate about the pivot axis 6 in a suitable manner, preferably being mounted on the channel block 3. In particular it is possible in this way to arrange outside of the channel 2 a restoring spring that acts on the bearing shaft 18 and prestresses the valve 5 in its starting position. Such a restoring spring is illustrated in FIG. 1, where it is labeled as 19.

As an alternative, an embodiment in which the valve 5 is mounted on the bearing shaft 18 to pivot about the pivot axis 6 is also possible. The bearing shaft 18 itself may then be arranged in a rotationally fixed manner. A corresponding restoring spring then acts directly on the valve 5, to which end it is arranged inside the channel 2.

Like the bearing shaft 18, the pivot axis 6 here is also arranged in the trough 11, i.e., is countersunk in the channel wall 12.

On its axial ends with respect to the pivot axis 6, the valve 5 here is equipped with side walls 20 which extend parallel to the channel wall in a wall niche 21 in the channel 2. This wall niche 21 may be shaped in such a way that it forms an end stop in the end position of the valve 5 shown in FIG. 3, with the valve 5 coming to rest against the stop on the respective side wall 20. The actuating device 7 is expediently designed in such a way that it can press the valve S with the actuator 8 against said end stop 22 so that secure positioning is achieved for the valve 5 in the end position. At the same time a radial valve end 23 with respect to the pivot axis 6 may also come to rest against a complementary abutment surface in the end position to thereby define the end position of the valve 5. Said abutment surface 24 may be formed, for example, on a partition wall 25, which subdivides the channel 2 into two partial channels, which are not identified further, in the area of the valve 5, one of which may be controlled with the help of the valve 5, in particular being blocked.

According to FIG. 1, the respective valve arrangement 4 may comprise a valve unit 26 which is inserted into the respective channel 2 where it forms a wall section 27 bordering the channel 2. The valve unit 26 here comprises two walls 28, 29 which are connected to one another by a bottom section 30. In the installed state, both the valve 5 and the actuator 8 are arranged in the valve unit 26. Furthermore, the pivot axis 6 and/or the axis of rotation 9 and/or the bearing shaft 18 and/or the drive shaft 10 extend through the valve unit 26. Production of the fresh gas system 1 is simplified with the help of such a valve unit 26.

According to FIGS. 5 and 6, with another valve arrangement 4, which is installed in the fresh gas system 1 illustrated in FIG. 4, the actuator 8 is designed as a gearwheel which is also labeled with the numeral 8 below. This gearwheel 8 is connected to the drive shaft 10 in a rotationally fixed manner, expediently by a suitable form-fitting connection. A gearwheel segment 31 is formed on the valve 5. For pivoting the valve 5, gearwheel 8 cooperates with the gearwheel segment 31, i.e., the gearwheel 8 meshes with the gearwheel segment 31. Here again, the gearwheel segment 31 is preferably designed on the back side 17 of the valve 5. Gearwheel segment 31 extends concentrically with the pivot axis 6. In the embodiment shown here, the pivot axis 6 extends in a central area through the channel 2, in particular in a plane in which the partition 25 also extends. Here again the valve 5 has two side walls 32 which are connected to one another by a common valve body 33 and which extend away therefrom up to the pivot axis 6, The gearwheel segment 31 is designed on the valve body 33. In addition, the valve body 33 assumes the control function of the valve 5.

Here again, the valve 5 is preferably arranged so that it is countersunk in the channel wall 12 in the starting position, to which end the channel wall may again be equipped with a trough 11. The front side 14 of the valve 15 is also designed to be shape-integrated with regard to the inside contour 15 of the channel wall 12 for the starting position.

The gearwheel 8 is also arranged countersunk in the channel wall 12. In the special embodiment shown here, the channel wall 12 has an opening 34 in the area of the gearwheel 8 so that the gearwheel 8 protrudes through this opening from the outside through the channel wall 12 into the channel 2 and/or into the trough 11 as far as the gearwheel segment 31. On a side facing away from the channel 2, said opening 34 is closed by a cover 35 which surrounds the gearwheel 8 and the drive shaft 1a. Through appropriate contouring or formation of a niche on channel walls adjacent to the side walls 32 of the valve 5 and/or walls 36 insertable into the channel 2, an end stop 37 for the end position shown in FIG. 6 and/or another end stop 38 for the starting position for valve 5 shown in FIG. 5 can be implemented.

In the embodiment shown here, the valve 5 is equipped with two bearing journals 39 extending coaxially with the pivot axis 6. The bearing journals 39 are formed on the side walls 32 and are each mounted so they can rotate about the pivot axis 6 in a pivot bearing 40. These pivot bearings 40 are preferably designed in the walls 36 inserted into the channel 2 and/or into the channel block 3. These walls 36 in turn form wall sections of the channel 2.

For a definition of the end position shown in FIG. 6, an end edge 41 on the outgoing flow side may be adapted to the abutment surface 24 and may come to rest against the latter on reaching the end position. By means of the gearwheel 8, the valve 5 may be pressed in the end position against the end stop 37 and against the abutment surface 24 to stabilize the end position. In this embodiment, gearwheel 8 may also stabilize the starting position by the fact that the gearwheel 8 presses the valve 5 against the other end stop 38 associated with the starting position.

FIG. 4 shows another particular feature of this valve arrangement 4. The gearwheel 8 is lengthened axially with one cylinder 42 on each of its two axial ends. The two cylinders 42 and the gearwheel 8 preferably form a component that is manufactured in one piece. The two cylinders 42 are expediently arranged on the drive shaft 10 in a rotationally fixed manner, in particular being placed there in a form-fitting manner. In the installed state, the cylinders 42 are mounted in the bearing sleeves 43 so they can rotate about the axis of rotation 9. In this way, the drive shaft 10 is also mounted in the bearing sleeves 43 to rotate about the axis of rotation 9 via the cylinders 42.

The bearing sleeves 43 are therefore inserted into first bearing half shells 44 which are formed on the channel block 3. Second bearing half shells 45 are formed on the cover 35 and complete the support and/or mounting of the bearing sleeves 43.

According to FIG. 1, in one embodiment of the fresh gas system 1 in which at least two, usually all channels 2 are each equipped with such a valve arrangement 4 and have a common actuating drive 46 which is assigned to all the actuating devices 7 of all the valve arrangements 4. Then a joint drive shaft 10 is expediently also provided, said drive shaft being attached in a rotationally fixed manner to the actuators 8 of the respective actuating devices 4. In this way, all the valves 5 can be actuated in synchronization in an especially simple manner with the help of the joint actuating drive 46.

A joint bearing shaft on which the valves 5 of the respective actuating devices 4 are jointly arranged is preferably also provided for bearing the valves 5. The joint drive shaft 10 and/or the joint bearing shaft 18 is/are also suitable in assembly of the fresh gas system 1 for securing the components of the valve arrangements 4, which are inserted into the channel block 3, on the channel block 3 in a form-fitting manner.

According to FIG. 4, a variant in which a joint drive shaft 10 is provided is also preferred in this embodiment, the actuators 8 of all participating bearing arrangements 4 being arranged on this drive shaft in a rotationally fixed manner and drivable by a joint actuating drive 46. In addition, a joint cover 35 is provided in this embodiment for covering the joint drive shaft 10, the actuators 8 and the bearing arrangements 42, 43, 44, 45 and for closing the openings 34.

The valves 5 shown here are designed as tumble valves in an exemplary manner; with their help a shift charge operation for the internal combustion engine can be implemented in particular. Likewise the valves 5 may be swirl valves or any other valves 5, e.g., throttle valves which are arranged in the channels 2 of the fresh gas system 1 in a cylinder-specific arrangement.

1-8. (canceled)

9. An arrangement of a valve in a channel of a fresh gas system for supplying fresh gas to an internal combustion engine, in particular in a motor vehicle,
with an actuating device for pivoting the valve about a pivot axis,
wherein the actuating device has an actuator which acts on the valve eccentrically with respect to the pivot axis to pivot the valve in its actuation.

10. The valve arrangement according to claim 9, wherein the actuator, when actuated, rotates about an axis of rotation that runs parallel and eccentrically to the pivot axis and is connected in a rotationally fixed manner to a drive shaft, which runs parallel and eccentrically to the pivot axis,

11. The valve arrangement according to claim 9, wherein the axis of rotation and/or the drive shaft is arranged so it is countersunk in a channel wall bordering the channel.

12. The valve arrangement according to claim 9, wherein the actuator is designed as a gearwheel connected to a drive shaft in a rotationally fixed manner and cooperating with a gearwheel segment designed thereon to pivot the valve.

13. The valve arrangement according to claim 9, wherein the gearwheel segment extends concentrically with the pivot axis.

14. The valve arrangement according to claim 9, wherein the gearwheel segment is designed on a back side of the valve facing away from the fresh gas flow.

15. The valve arrangement according to claim 9, wherein the gearwheel is arranged so it is countersunk in a channel wall bordering the channel.

16. The valve arrangement according to claim 9, wherein the gearwheel is lengthened with a cylinder on each of the two axial ends, each cylinder being mounted to rotate about the axis of rotation in a bearing sleeve.

17. The valve arrangement according to claim 9, wherein the actuator is designed as a cam which is connected to a drive shaft in a rotationally fixed manner and which cooperates with a cam slider formed thereon for pivoting the valve.

18. The valve arrangement according to claim 9, wherein the cam slider is designed on a back side of the valve facing away from the fresh gas flow.

19. The valve arrangement according to claim 9, wherein the pivot axis is arranged countersunk in a channel wall bordering the channel.

20. The valve arrangement according to claim 9, wherein the valve is arranged on a bearing shaft extending coaxially with the pivot axis.

21. The valve arrangement according to claim 9, wherein the valve is mounted on the bearing shaft so it can pivot about the pivot axis.

22. The valve arrangement according to claim 9, wherein the valve is arranged on the bearing shaft in a rotationally fixed manner and the bearing shaft is mounted to rotate about the pivot axis.

23. The valve arrangement according to claim 9, wherein the valve is pre-stressed into a starting position by means of a restoring spring.

24. The valve arrangement according to claim 9, wherein the restoring spring acts on the valve or on the bearing shaft connected to the valve in a rotationally fixed manner.

25. The valve arrangement according to claim 9, wherein the valve has two bearing journals, each being mounted in a pivot bearing to rotate about the pivot axis.

26. The valve arrangement according to claim 97 wherein the two pivot bearings are each designed in a wall inserted into the channel as a wall section bordering the channel.

27. The valve arrangement according to claim 9, wherein a valve unit forming a wall section bordering the channel is inserted into the channel, the valve and the actuator being arranged in this wall section, and the pivot axis and/or the axis of rotation and/or the bearing shaft and/or the drive shaft passing through the channel.

28. The valve arrangement according to claim 9, wherein the valve is pressed together with the actuator against an end stop in at least one end position,

29. A fresh gas system for supplying fresh gas to an internal combustion engine, in particular in a motor vehicle,
having a plurality of channels for supplying fresh gas to individual cylinders of the internal combustion engine;
at least one of the channels being equipped with a valve arrangement according to Claim 1.

30. The fresh gas system according to claim 29, wherein at least two or all channels are equipped with such a valve arrangement.

31. The fresh gas system according to claim 29, wherein at least two or all of the actuating devices have a common actuating drive for actuating their actuators.

32. The fresh gas system according to claim 29, wherein on at least two or all of the actuating devices the actuators are arranged on a common drive shaft in a rotationally fixed manner.

33. The fresh gas system according to claim 29, wherein the joint actuating drive is drive-coupled to the joint drive shaft.

34. The fresh gas system according to claim 29, wherein in at least two or all of the actuating devices the valves are arranged on a joint bearing shaft.

35. The fresh gas system according to claim 29, wherein all valves arranged on the joint bearing shaft in a rotationally fixed manner are pre-stressed into a starting position by means of a joint restoring spring (acting on the joint bearing shaft.

36. The fresh gas system according to claim 29, wherein the valves serve as tumble valves or as swirl valves.
